(19) United States
(12) Patent Application Publication
(10) Pub. No.: US 2004/0155862 A1
(43) Pub. Date: Aug. 12, 2004

(54) Universal detachable cursor control member for an electronic component

(76) Inventor: Timothy B. Higginson, Highland Park, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/664,320

(22) Filed: Sep. 17, 2003

Related U.S. Application Data
(60) Provisional application No. 60/432,188, filed on Dec. 10, 2002.

(51) Int. Cl. G09G 5/00

(52) U.S. Cl. 345/156

(57) ABSTRACT

An electronic device is provided which includes a base, a display and a cursor control member. The cursor control member includes a housing. The cursor control member has an attachment element arranged at one end of the housing for detachably fixing the cursor control member to the base. A port is carried by the base for receiving the attachment element of the cursor control member. The port is adapted to translate movement of the cursor control member into control signals for directing movement of a cursor in the display when the cursor control member is engaged with the port.

### FIELD OF THE INVENTION

This invention pertains to pointing devices for electronic components.

### BACKGROUND OF THE INVENTION

A pointing device has long been a common peripheral for personal computers. A pointing device allows a user to control movement of a cursor or pointer on the display screen of the computer and is useful in many graphical user interfaces. The most common form of a pointing device is the electronic mouse. Other types of pointing devices include a touch pad, a cursor control member, a wheel and a trackball.

Graphical user interfaces are also now commonly found on many portable electronic devices or components. As a result, many portable electronic devices include some sort of pointing device that permits the user to move a cursor or pointer on a display screen. The pointing devices used with portable electronic components can take a variety of different forms. For example, notebook or laptop computers often use a touch pad. Handheld personal digital assistants often use a stylus. Frequently, even mobile telephones use a pointing device in the form of buttons or wheels on the body of the telephone.

Unfortunately, the pointing devices used with portable electronic components do not offer anywhere near the level of user control that is achievable with a personal computer and mouse. For example, many users find the touchpads and mini-cursor control members used with laptop computers very difficult to manipulate. Moreover, pointing devices including those used with personal computers offer little in the way of additional functionality to the electronic device beyond cursor control.

### BRIEF SUMMARY OF THE INVENTION

The invention provides an electronic device having a base, which can include a processing unit, a display and a cursor control member. The cursor control member includes a housing. The cursor control member has an attachment element arranged at one end of the housing for detachably securing the cursor control member to the base. A port is carried by the base for receiving the attachment element of the cursor control member. The port is adapted to translate movement of the cursor control member into control signals for directing movement of a cursor in the display when the cursor control member is engaged with the port.

In one embodiment of the invention, the electronic device can include a locking mechanism for securing the cursor control member to the port on the base so as to prevent unintentional withdrawal of the cursor control member from the port. The locking mechanism includes a release mechanism operable to unlock the cursor control member from the port so that the cursor control member can be removed from the port.

In another embodiment of the invention, the attachment element of the cursor control member and the port can have complementary configurations such that the cursor control member cannot rotate about its longitudinal axis relative to the movable surface on the base when the cursor control member is engaged with the port. The attachment element of the cursor control member and the port can also have complementary guide surfaces which engage each other upon insertion of the cursor control member into the port and guide the attachment element of the cursor control member into position for engagement with the port.

In another embodiment, the port and the attachment element of the cursor control member can be configured such that content stored in the memory of the cursor control member can be communicated to the processing unit in the base when the cursor control member is engaged with the port. The port and attachment element of the cursor control member can also be configured such that the memory of the cursor control member is usable by the processing unit in the base when the cursor control member is engaged with the port. Additionally, the port and attachment element of the cursor control member can be configured such that power produced by the power supply in the cursor control member is available to operate the processing unit in the base when the cursor control member is engaged with the port.

In one embodiment, the electronic device can include a storage slot on the base which is configured to receive the cursor control member. An end of the cursor control member can also be configured as a stylus tip.

### BRIEF DESCRIPTION OF THE DRAWINGS

FIG. 1 is a perspective view of an exemplary universal detachable cursor control member being used with a portable electronic component or device according to the present invention.

FIG. 2 is a side elevation view of one embodiment of a detachable cursor control member according to the invention in which the cursor control member has an attachment element configured as a plug.

FIG. 3 is an end view of the attachment element end of the detachable cursor control member of FIG. 2.

FIG. 4 is an enlarged partial perspective view of the attachment element end of the detachable cursor control member of FIG. 2 and a correspondingly configured mating port of an electronic component. In this embodiment, the attachment element of the cursor control member includes a plurality of plugs which mate with a corresponding port on the electronic component that comprises an array of receptacles such that the cursor control member cannot be rotated about its longitudinal axis relative to the electronic component.

FIG. 5 is a side elevation view of another embodiment of a detachable cursor control member according to the invention in which the cursor control member has an attachment element configured as a receptacle.

FIG. 6 is an end view of the attachment element end of the detachable cursor control member of FIG. 5.

FIG. 7 is enlarged partial perspective view of the attachment element end of the detachable cursor control member of FIG. 5 and a correspondingly configured mating port of an electronic component.

FIG. 8 is a side elevation view of yet another embodiment of a detachable cursor control member according to the invention which includes control buttons and a control wheel and which has an attachment element configured as a receptacle which can mate with a port on an electronic component in the form of a mating protrusion such as, for example, a permanently affixed mini-joystick.

FIG. 9 is an end view of the attachment element end of the detachable cursor control member of FIG. 8.

FIG. 10 is an enlarged partial perspective view of the detachable cursor control member of FIG. 8 and the mating protrusion on an electronic component.

FIG. 11 is a side elevation view of another embodiment of a detachable cursor control member according to the present invention in which the cursor control member includes a joint which permits movement of the upper portion of the cursor control member relative to the attachment element of the cursor control member.

FIG. 12 is an end view of the detachable cursor control member of FIG. 11.

FIG. 13 is an enlarged partial perspective view of the attachment element of the detachable cursor control member of FIG. 11 and the mating port of an electronic component.

FIG. 14 is an enlarged partial side elevation view of the detachable cursor control member of FIG. 11 engaged with the mating electronic component port showing how the upper portion of the cursor control member can move relative to the attachment element of the cursor control member.

FIG. 15 is an enlarged side elevation view of another embodiment of a detachable cursor control member and mating electronic component port according to the present invention in which the attachment element of the cursor control member includes a selectively releasable locking mechanism that engages corresponding locking recesses in the mating port on the electronic component.

FIG. 16 is a perspective view illustrating a detachable cursor control member according to the invention connected to a computer keyboard.

FIG. 17 is a perspective view illustrating a detachable cursor control member according to the invention connected to a computer keyboard.

FIG. 18 is a perspective view illustrating a detachable cursor control member according to the invention connected to a notebook computer.

FIG. 19 is a perspective view illustrating a detachable cursor control member according to the invention connected to a universal keypad.

FIG. 20 is a perspective view illustrating a detachable cursor control member according to the invention connected to a mobile telephone.

FIG. 21 is a perspective view of the attachment element of another embodiment of a detachable cursor control member and mating electronic component port according to the present invention in which the attachment element of the cursor control member and the mating port are configured so as to prevent rotation of the cursor control member about its longitudinal axis relative to the mating port.

FIG. 22 is a side elevation view of another embodiment of a detachable cursor control member according to the invention in which the cursor control member includes a locking mechanism release button at the upper end of the cursor control member.

FIG. 23 is a side elevation view of another embodiment of a detachable cursor control member according to the invention that is similar to the FIG. 22 embodiment but larger in length and diameter.

FIG. 24 is perspective view of another embodiment of a detachable cursor control member according to the invention that includes a plurality of control buttons and a control wheel showing how the cursor control member can be manipulated by a human hand.

FIG. 25 is a perspective view of another embodiment of a detachable cursor control member and mating electronic component receptacle according to the invention in which the mating receptacle is carried on an element that plugs into a standard port on a mobile telephone.

FIG. 26 is a perspective view illustrating how a detachable cursor control member according to the present invention can be stored in a storage slot in a personal digital assistant (PDA).

FIG. 27 is a perspective view of another embodiment of a detachable cursor control member and mating electronic component receptacle of the present invention in which the attachment element of the cursor control member and the mating port are configured to assist in centering the cursor control member in the receptacle during insertion and wherein the attachment element end of the cursor control member is also configured to provided stylus-like functionality.

### DETAILED DESCRIPTION OF THE INVENTION

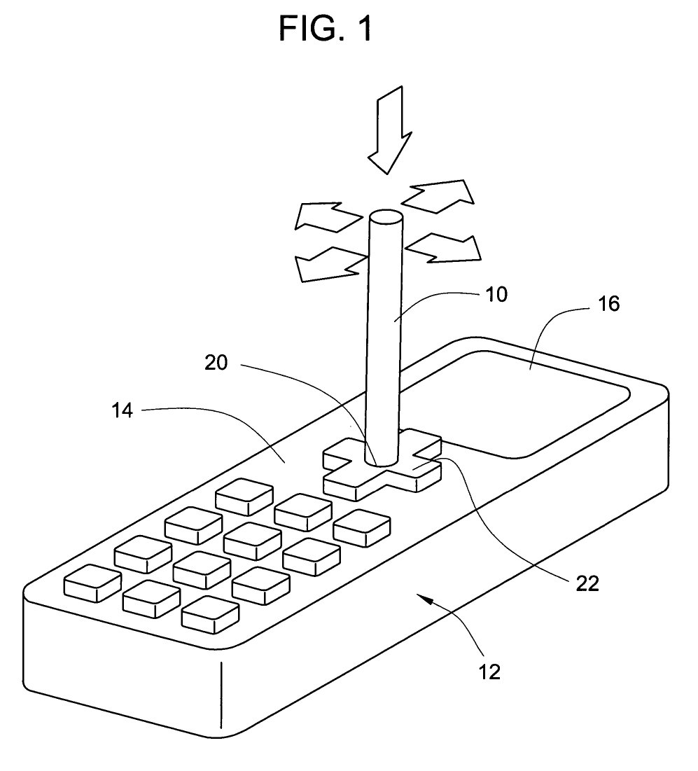

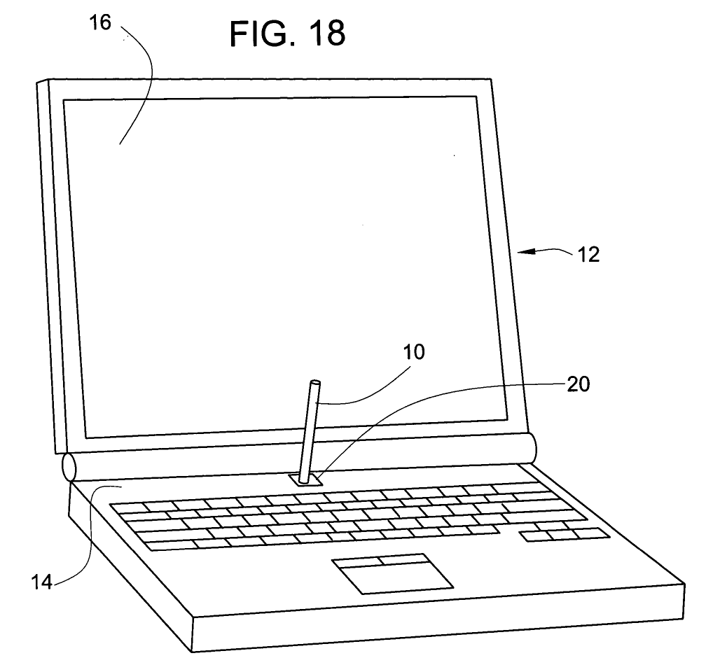

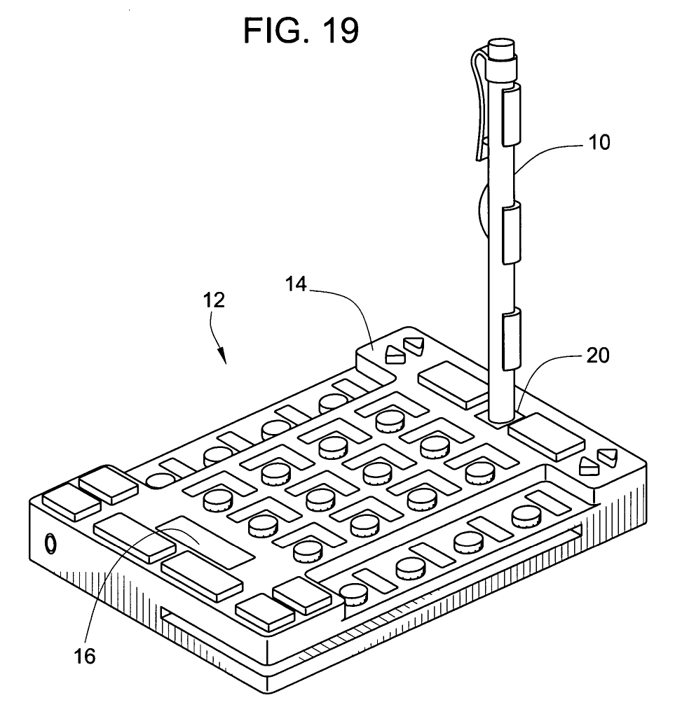

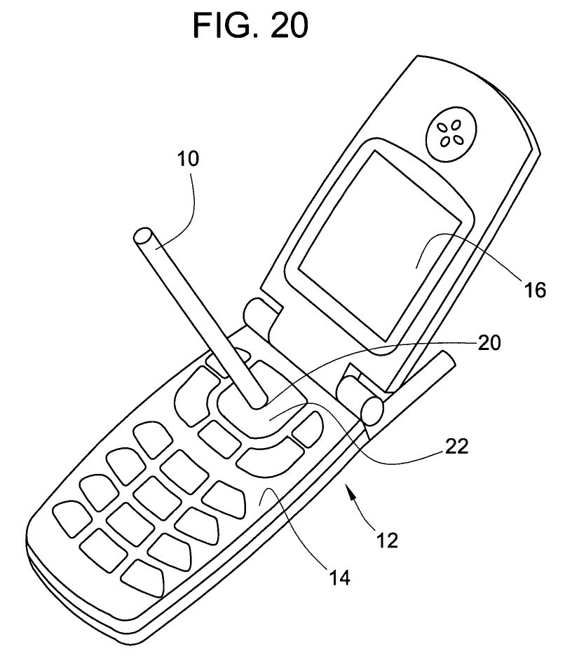

Referring more particularly to the drawings, various different exemplary embodiments of a removable or detachable cursor control member 10 according to the invention are shown. The removable cursor control member of the present invention has universal applicability in that it can be easily attached to any type of electronic device or component 12 (including, for example, PDAs, mobile telephones, laptop computers, PC keyboards, portable keypads, etc.) in order to provide joystick-like cursor control as well as entry of system and application commands. Such electronic devices generally include some sort of base 14 and a display 16 (see, e.g., FIGS. 1 and 18-20). When not in use, the universal cursor control member 10 of the present invention detaches from the electronic device 12 quickly and easily by hand without any need for separate tools or disassembly of the electronic device. In some embodiments, the detachable cursor control member 10 can also provide memory, user feedback and power to the electronic device 12 or component to which it is attached. Advantageously, there is no need for a cable attaching the cursor control member 10 to the electronic device 12. Moreover, the cursor control member 10 does not have a base unit that sits on a table or desktop or some other surface.

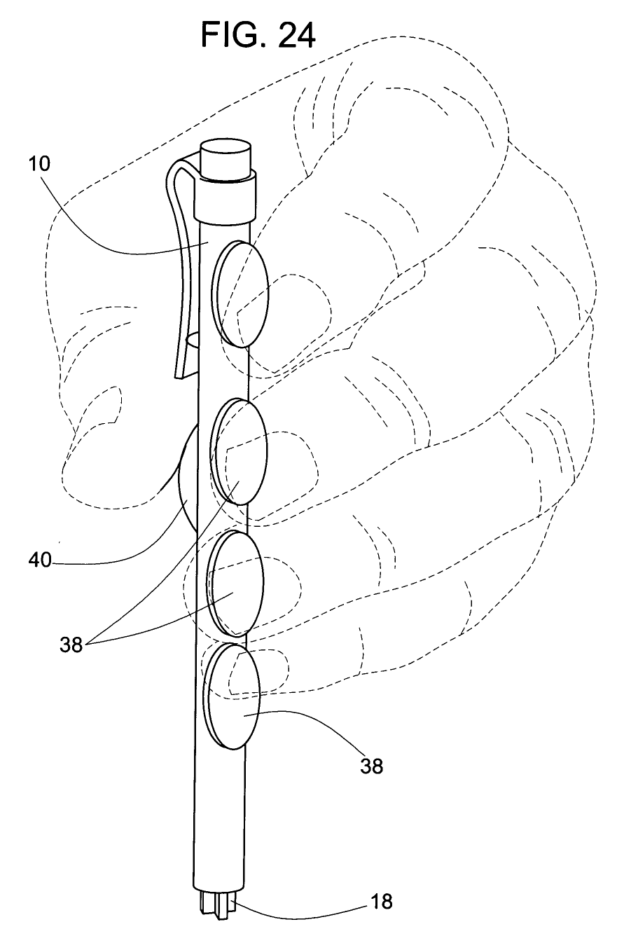

To this end, the detachable cursor control member 10 generally includes an attachment element 18 (at one end of cursor control member 10 in the illustrated embodiment) that is configured to engage a complementarily configured port 20 on the electronic device 12 (see, e.g., FIGS. 1, 4, 7, 10 and 21). The port 20 receives and holds the removable cursor control member 10 and is adapted to translate instructions from the detachable cursor control member 10 into control signals for directing movement or operation of a cursor in the display of the electronic device 12. The instructions from the cursor control element 10 are based on hand or finger manipulation of the cursor control member by a user (see, e.g., FIG. 24). In particular, a user inputs instructions into the cursor control member 10 via either relative movement of the cursor control member 10 or finger pressure/manipulation of control buttons/surfaces on the cursor control member.

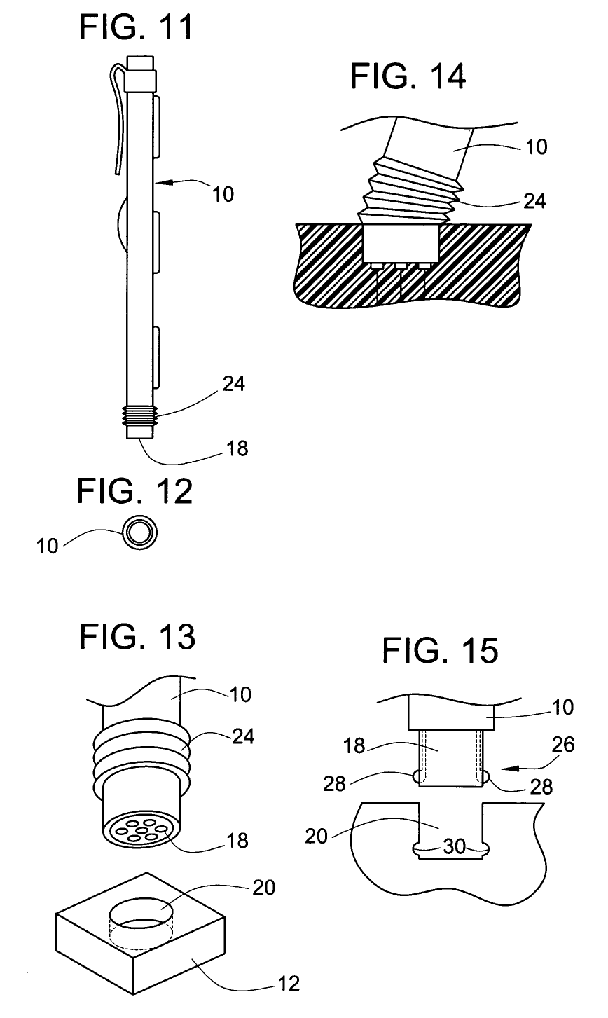

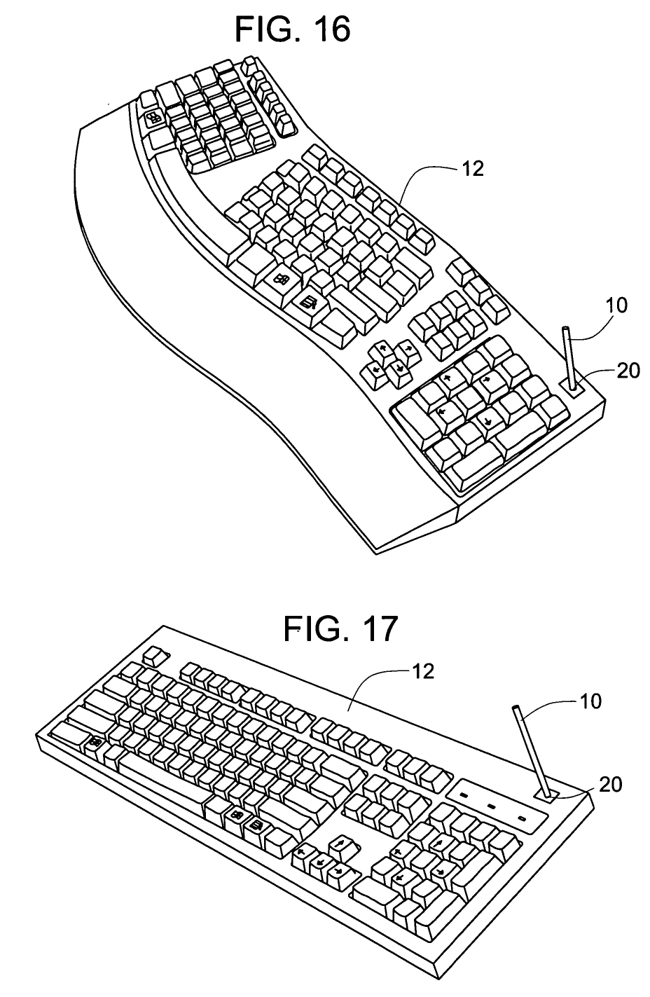

Preferably, the relative movement is achieved by providing the port 20 on a movable surface 22 of the electronic device 12 (best shown in FIGS. 1 and 16-20) that moves relative another portion of the electronic device in response to movement of the cursor control member 10 when the cursor control member is engaged with the port 20. This arrangement allows the cursor control member 10 to have a rigid construction that makes it easier to engage the cursor control member with the port 20. Also, moveable surfaces are sometimes already used as a cursor movement device on some electronic devices such as mobile telephones as shown, for instance, in FIG. 20. In such a case, the port 20 can be implemented into the existing moveable surface 22 thereby eliminating the need for a separate or new structure for facilitating the relative movement. Alternatively, the detachable cursor control member 10 could be configured such that it has a joint 24 or the like which permits one portion of the cursor control member 10 to move relative to another portion of the cursor control member as shown for example in FIGS. 11-14. As noted above, one disadvantage of such a joint 24 is that it could flex when a user tries to insert the cursor control element 10 into the port 20 making it more difficult to achieve proper engagement of the cursor control element.

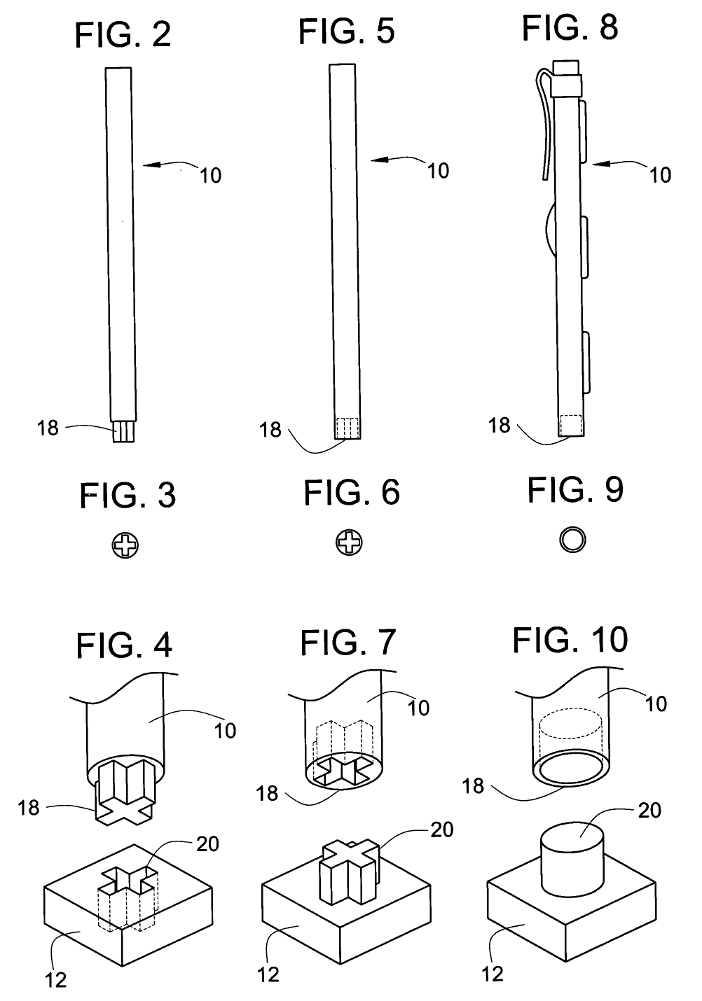

One way in which the connection between the attachment element 18 of the detachable cursor control member 10 and the corresponding port 20 on the electronic device 12 can be implemented is by a male/female type connection. For example, in the embodiments illustrated in FIGS. 2-4, the attachment element 18 of the cursor control member 10 comprises a male plug that is received in a port 20 on the electronic device 12 that is configured as a mating female receptacle. Conversely, in the embodiments of the invention illustrated in FIGS. 5-10, the attachment element 18 of the cursor control member 10 is configured as a female receptacle and the electronic device 12 includes a port 20 in the form of protrusion, such as, for example a permanently affixed mini-joystick. If desired, the female receptacle portion of the connection (either on the electronic device 12 or cursor control member 10) can be provided with a cover to help prevent the accumulation of dust, dirt and other debris in the receptacle.

To facilitate use of the cursor control member 10, the attachment element 18 of the cursor control member 10 and the electronic device port 20 can have a mating physical structure that prevents unintentional rotation of the cursor control member around its longitudinal axis when it is engaged with the port. For example, as illustrated in FIGS. 2-7 and 21, both the male and female portions can be configured with a plurality of radiating legs (four legs in the illustrated embodiment) that can interlock so as to prevent rotation of the cursor control member 10 relative to the port 20. Alternatively, the male/female connection can incorporate a plurality of mating plugs and receptacles. In the embodiment illustrated in FIGS. 13 and 14, the attachment element 18 includes a plurality of protrusions which mate with a plurality of receptacles in the port 20 when the cursor control element 10 is engaged with the port and prevent the cursor control member from rotating relative to the port. Any number of other complementary configurations can be used with respect to the attachment element 18 and the port 20 in order to prevent rotation of the cursor control member 10 relative to the port when the cursor control member is engaged with the port.

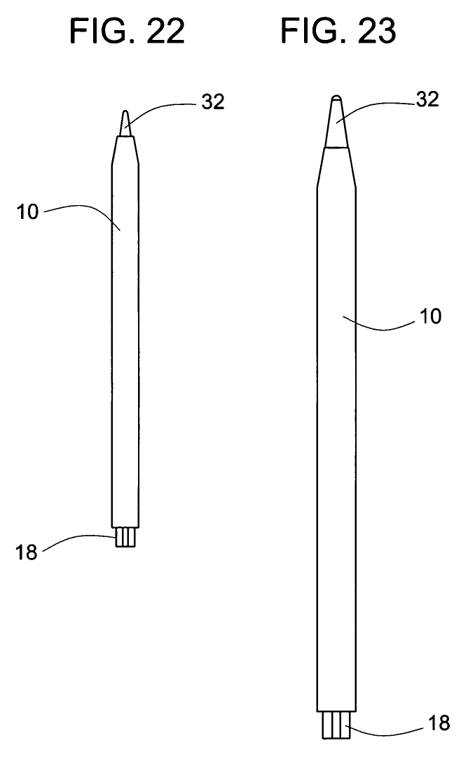

To prevent unintentional removal of the cursor control element 10 from the port 20, a locking mechanism 26 can be provided. For example, as shown in FIG. 15, the locking mechanism 26 can comprise a plurality of locking elements 28 on the cursor control member 10 that are engageable with a plurality of complementary locking recesses 30 in the port 20. In this case, the locking mechanism 16 also prevents rotation of the cursor control member 10 about its longitudinal axis when the cursor control member is engaged with the port 10. The locking elements 28 in the illustrated embodiment are spring loaded so that the locking elements will retract to allow the cursor control element 10 to be inserted into the port 20 and then spring outward into engagement with the complementary locking recesses 30. The locking mechanism 26 can be selectively releasable such as by operation of a release mechanism, which in one embodiment could include a release button 32 located at the upper end of the cursor control member 10 (see FIGS. 22 and 23). The release mechanism can be operable to unlock the locking mechanism 26 such as by withdrawing the locking elements 28 from engagement with the locking recesses 30 thereby allowing easy intentional removal of the cursor control member 10 from the electronic device 12. If desired, the location of the components of the locking mechanism 26 could be reversed with the locking recesses being provided on the cursor control member 10 and the retractable locking elements being provided in the port 20.

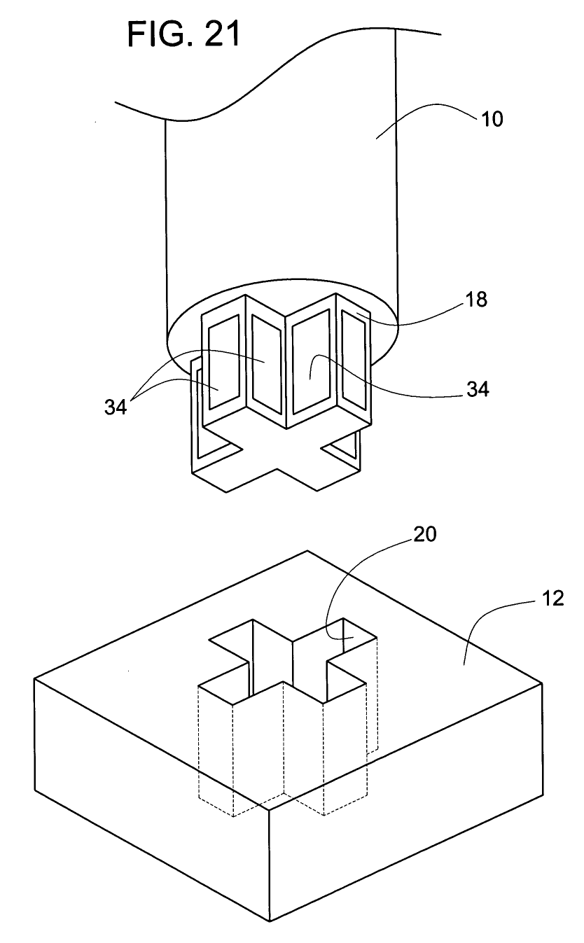

As shown for example in FIG. 21, the connection between the cursor control member 10 and the port 20 can include contact points 34 for passing electronic signals from the cursor control member 10 to the electronic device 12 (and vice versa). The use of contact points 34 at the interface between the attachment element 18 of the cursor control member 10 and port 20 of the electronic device 12 is one method by which the cursor control member and electronic device can communicate. For example, signals produced by operation of control buttons or wheels on the cursor control member 10 can be communicated to the electronic device 12 through the contact points 34. Additionally, other signals such as from a power source carried by the cursor control member 10 or signals carrying information from memory provided in the cursor control member 10 could also be communicated to the electronic device 12 through the contact points 34 as described in more detail below. Signals can also be passed from the electronic device 12 to the cursor control member 10 through the contact points 34. For example, the electronic device 12 could provide feedback to the cursor control member 10 through the contact points 34 such as by directing motion of the cursor control member 10 upon occurrence of a predetermined event. The predetermined event could be the cursor reaching a graphic user interface icon in the display or some event in a game. The contact points 34 can also be used to transmit control signals corresponding to the relative motion of the portions of the cursor control member 10 above and below the joint 24. It will be understood that methods other than contact points can be used to communicate signals between the cursor control member 10 and the mating electronic device 12 including wireless transmission of signals.

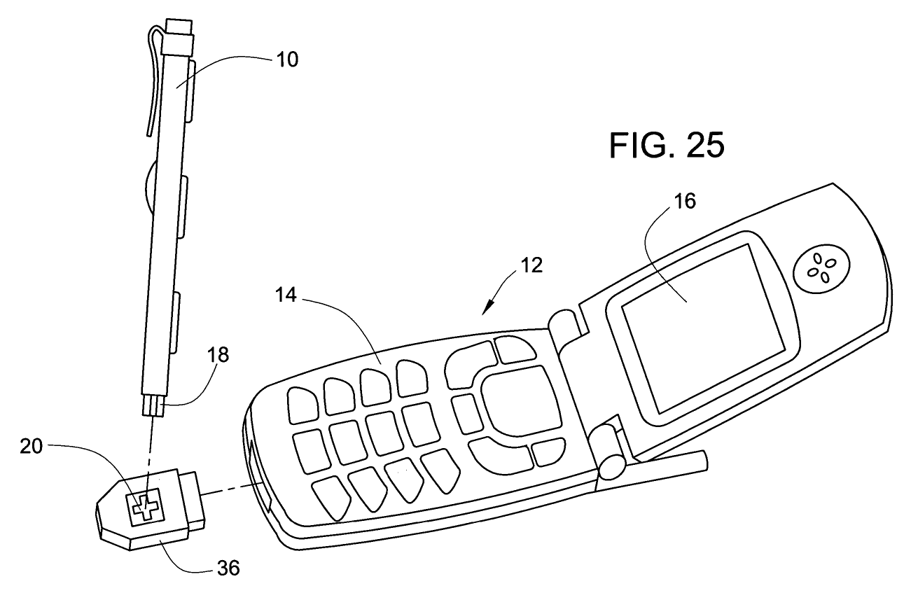

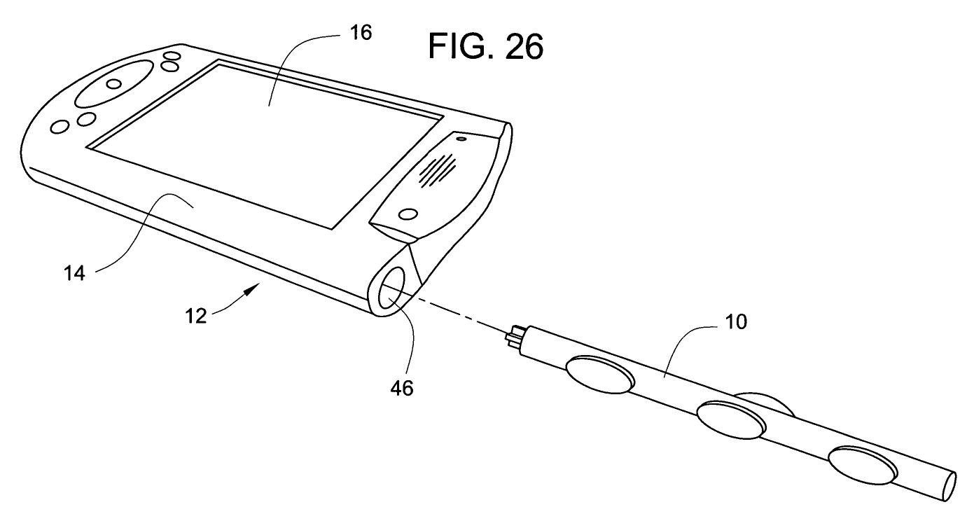

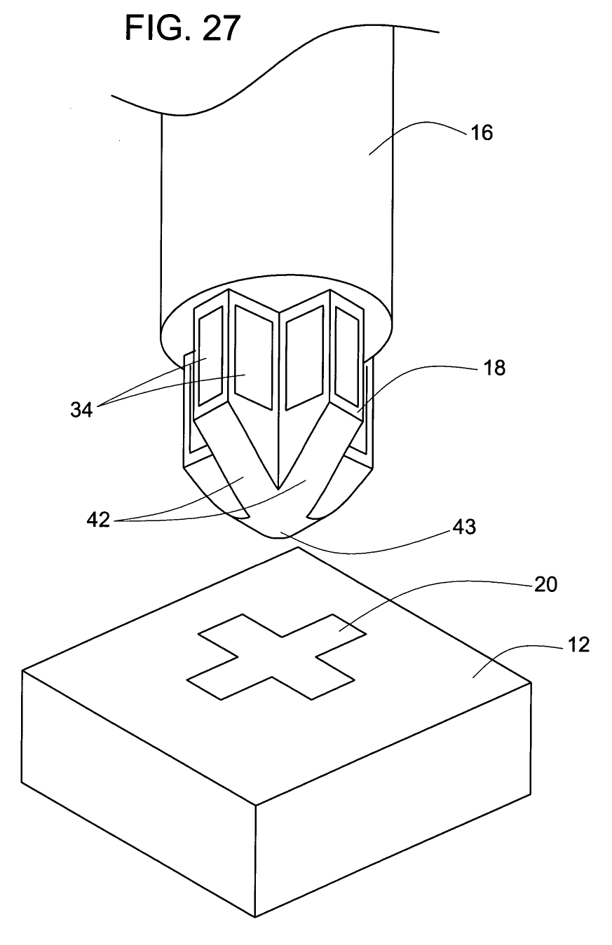

As will be appreciated, the port 20 can be located anywhere on the electronic component. Preferably, however, the port 20 is located in a position where a user can easily operate the cursor control member 10 while viewing the display of the electronic device 12. Moreover, instead of being permanently affixed to the electronic device 12, the port 20 could be provided on a separate component 36 that itself can be removably connected to the electronic device 12 as shown in FIG. 25. The port 20 that mates with the detachable cursor control member 10 could also include a portion of an existing cursor movement device on the electronic device 12. For example, the detachable cursor control member 10 could connect to the permanently affixed mini-joystick found on some notebook computers.

In the embodiment illustrated in FIG. 24, the cursor control member 10 includes a plurality of buttons 38 arranged along the length of the cursor control element 10 and a control wheel 40 all of which can be used to input instructions to the electronic device 12. Any control buttons, wheels or surfaces carried on the cursor control member 10 can be configured to operate in any manner. For example, because depressing buttons in a direction perpendicular to the longitudinal axis of the cursor control member 10 can make the cursor control member more difficult to manipulate, the buttons 38 could be configured to operate at angle upward or downward relative to the longitudinal axis of the cursor control member. Alternatively, the buttons 38 could be configured to operate upon generally rotary motion relative to the longitudinal axis of the cursor control member 10. It will be understood, however, that the present invention is not limited to any particular method for manipulation of buttons or other hand operable elements carried by the cursor control member 10.

To facilitate engagement of the cursor control member 10 with the port 20 on the electronic device 12, the attachment element 18 and port 20 can have complementary guide surfaces which engage each other upon insertion of the cursor control member into the port and guide the attachment element of the cursor control member into position for proper engagement with the port. An embodiment of the cursor control element 10 having such a configuration is shown in FIG. 27. In this embodiment, the leading edges 42 of the attachment element 18 of the cursor control member 10 taper upwards (with reference to the drawing) and away from a point 43. These tapered edges 42 mate with correspondingly tapered surfaces 44 in the port 20 upon insertion of the attachment element 18 into the port. In addition to helping to properly center the cursor control member 10 in the port, the point 43 at the end of the cursor control element allows the cursor control member to be used like a PDA stylus.

A stylus or pen-shaped cursor control member 10 (i.e., a cursor control member having an elongate, slender, rigid construction) offers many advantages in that it is slim and easy to store. For example, the cursor control member 10 can be stored in a storage slot 46 provided on the electronic device 12 such as shown in FIG. 26. Such a configuration also makes it easy to carry multiple cursor control members 10 that can be selectively attached to a variety of different electronic devices 12. Moreover, the added length as compared to the mini-joysticks that are attached to many laptop or notebook computers allows for much more precise cursor control. In one presently contemplated exemplary embodiment, the cursor control member 10 would be approximately 3½-5 inches in length. However, it will be appreciated that the detachable cursor control member 10 can have any size (compare FIGS. 22 and 23), shape or configuration including a ball shape or a fist/pistol grip.

The cursor control member 10 can be a “dumb” version which only provides joystick-type control functionality through physical movement of the cursor control member 10 as a whole. It can also be a “smart” version which includes features such as (1) touch control surfaces and/or (2) internal capabilities such as battery power, memory storage, and software applications and media/content accessible or downloadable through the port 20. Moreover, in the smart version of the cursor control member 10, the information/signal flow between the electronic device 12 and the detachable cursor control member can be two-way, e.g., for feedback and memory. One specific example of a “smart” feature is the cursor control member 10 can have memory and the attachment element 18 of the cursor control member 10 and the port 20 can be configured such that content stored in the memory of the cursor control element (e.g., games, movies, etc.) can be communicated to a processing unit in the electronic device 12 when the cursor control member 10 is engaged with the port 20. Alternatively, the processing unit also could be in the cursor control member. Another variation on such a feature is that the attachment element 18 and the port 20 can be configured such that the memory in the cursor control member 10 is useable by the electronic device 12 when the cursor control element 10 is engaged with the port 20. Another specific example of a “smart” feature is the cursor control element 10 can be provided with a power supply and the attachment element 18 and port 20 can be configured such that the cursor control member power supply is available to operate the electronic device 12. In such case, the cursor control member 10 could act as an auxiliary power supply for the electronic device 12. Conversely, the attachment element 18 and port 20 can be configured such that the power supply of the electronic device 12 also provides any necessary power for the cursor control element 10.

As will be appreciated, the universal cursor control member 10 of the present invention essentially super-charges the PDA-stylus and transforms it into a full functionality, removable joystick. This provides an entirely new level of user control of portable and other types of electronic devices, including, for instance: (1) substantially improved cursor control; (2) mouse-like functionality; (3) entertainment game joystick functionality; (4) external batteries; (5) additional memory; and (6) access to media/content stored internally on a read-only or downloadable basis in the cursor control member body (analogous to pre-programmed VCR tapes and DVDs containing movies or cards for portable electronic game players). The removable cursor control member also offers content providers a new and secure means to provide content to these devices that is, at the same time, much easier for the user of the device to access (than, for instance, downloading from the Internet); essentially, for instance, a movie company could store a movie on a removable cursor control member, sell or rent the cursor control member much as VCR tapes are rented or sold, and the user just plugs the cursor control member into the device and the content plays.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electronic device comprising:
a base;
a display;
a cursor control member including an elongate, slender, rigid housing, the cursor control member having an attachment element arranged at one end of the housing for detachably fixing the cursor control member to the base;
a port carried by the base for receiving the attachment element of the cursor control member, the port including a movable surface that moves in response to movement of the cursor control member when the cursor control member is engaged with the port, movement of the movable surface producing control signals for directing movement of a cursor in the display; and
a locking mechanism for securing the cursor control member to the port on the base so as to prevent unintentional withdrawal of the cursor control member from the port, the locking mechanism including a release mechanism operable to unlock the cursor control member from the port so that the cursor control member can be removed from the port.

2. The electronic device according to claim 1 wherein the port is arranged on an adapter that is releasably connectable to the base.

3. The electronic device according to claim 1 wherein the cursor control member includes a manually operable input mechanism that produces control signals when operated and the attachment element and port are configured so as to communicate those control signals to a processing unit in the base.

4. The electronic device according to claim 3 wherein the input mechanism comprises a button.

5. The electronic device according to claim 3 wherein the input mechanism comprises a wheel.

6. The electronic device according to claim 3 wherein the input mechanism comprises a touch surface.

7. The electronic device according to claim 1 wherein the attachment element of the cursor control member and the port have complementary configurations such that the cursor control member cannot rotate about its longitudinal axis relative to the movable surface on the base when the cursor control member is engaged with the port.

8. The electronic device according to claim 1 wherein the attachment element of the cursor control member and the port have complementary guide surfaces which engage each other upon insertion of the cursor control member into the port and guide the attachment element of the cursor control member into position for engagement with the port.

9. The electronic device according to claim 1 wherein an end of the cursor control member has a stylus tip.

10. The electronic device according to claim 1 wherein the cursor control member has a memory and the port and the attachment element of the cursor control member are configured such that content stored in the memory of the cursor control member can be communicated to a processing unit in the base when the cursor control member is engaged with the port.

11. The electronic device according to claim 1 wherein the cursor control member has a memory and the port and attachment element of the cursor control member are configured such that the memory of the cursor control member is usable by a processing unit in the base when the cursor control member is engaged with the port.

12. The electronic device according to claim 1 wherein the cursor control member includes a power supply and the port and attachment element of the cursor control member are configured such that power produced by the power supply in the cursor control member is available to operate the processing unit in the base when the cursor control member is engaged with the port.

13. The electronic device according to claim 1 further including a storage slot on the base, the storage slot being configured to receive the cursor control member.

14. An electronic device comprising:
a base;
a display;
a cursor control member including an elongate, slender, rigid housing, the cursor control member having an attachment element arranged at one end of the housing for detachably fixing the cursor control member to the base;
a port carried by the base for receiving the attachment element of the cursor control member, the port including a movable surface that moves in response to movement of the cursor control member when the cursor control member is engaged with the port, movement of the movable surface producing control signals for directing movement of a cursor in the display; and
wherein the attachment element of the cursor control member and the port have complementary configurations such that the cursor control member cannot rotate about its longitudinal axis relative to the movable surface on the base when the cursor control member is engaged with the port.

15. The electronic device according to claim 14 wherein the port is arranged on an adapter that is releasably connectable to the base.

16. The electronic device according to claim 14 wherein the cursor control member includes a manually operable input mechanism that produces control signals when operated and the attachment element and port are configured so as to communicate those control signals to a processing unit in the base.

17. The electronic device according to claim 16 wherein the input mechanism comprises a button.

18. The electronic device according to claim 16 wherein the input mechanism comprises a wheel.

19. The electronic device according to claim 16 wherein the input mechanism comprises a touch surface.

20. The electronic device according to claim 14 wherein the attachment element of the cursor control member and the port have complementary guide surfaces which engage each other upon insertion of the cursor control member into the port and guide the attachment element of the cursor control member into position for engagement with the port.

21. The electronic device according to claim 14 wherein an end of the cursor control member has a stylus tip.

22. The electronic device according to claim 14 wherein the cursor control member has a memory and the port and the attachment element of the cursor control member are configured such that content stored in the memory of the cursor control member can be communicated to a processing unit in the base when the cursor control member is engaged with the port.

23. The electronic device according to claim 14 wherein the cursor control member has a memory and the port and attachment element of the cursor control member are configured such that the memory of the cursor control member is usable by a processing unit in the base when the cursor control member is engaged with the port.

24. The electronic device according to claim 14 wherein the cursor control member includes a power supply and the port and attachment element of the cursor control member are configured such that power produced by the power supply in the cursor control member is available to operate the processing unit in the base when the cursor control member is engaged with the port.

25. The electronic device according to claim 14 further including a storage slot on the base, the storage slot being configured to receive the cursor control member.

26. An electronic device comprising:
a base;
a display;
a cursor control member including an elongate, slender, rigid housing, the cursor control member having an attachment element arranged at one end of the housing for detachably fixing the cursor control member to the base;
a port carried by the base for receiving the attachment element of the cursor control member, the port including a movable surface that moves in response to movement of the cursor control member when the cursor control member is engaged with the port, movement of the movable surface producing control signals for directing movement of a cursor in the display; and
wherein the attachment element of the cursor control member and the port have complementary guide surfaces which engage each other upon insertion of the cursor control member into the port and guide the attachment element of the cursor control member into position for engagement with the port.

27. The electronic device according to claim 26 wherein the port is arranged on an adapter that is releasably connectable to the base.

28. The electronic device according to claim 26 wherein the cursor control member includes a manually operable input mechanism that produces control signals when operated and the attachment element and port are configured so as to communicate those control signals to a processing unit in the base.

29. The electronic device according to claim 28 wherein the input mechanism comprises a button.

30. The electronic device according to claim 28 wherein the input mechanism comprises a wheel.

31. The electronic device according to claim 28 wherein the input mechanism comprises a touch surface.

32. The electronic device according to claim 26 wherein an end of the cursor control member has a stylus tip.

33. The electronic device according to claim 26 wherein the cursor control member has a memory and the port and the attachment element of the cursor control member are configured such that content stored in the memory of the cursor control member can be communicated to a processing unit in the base when the cursor control member is engaged with the port.

34. The electronic device according to claim 26 wherein the cursor control member has a memory and the port and attachment element of the cursor control member are configured such that the memory of the cursor control member is usable by a processing unit in the base when the cursor control member is engaged with the port.

35. The electronic device according to claim 26 wherein the cursor control member includes a power supply and the port and attachment element of the cursor control member are configured such that power produced by the power supply in the cursor control member is available to operate the processing unit in the base when the cursor control member is engaged with the port.

36. The electronic device according to claim 26 further including a storage slot on the base, the storage slot being configured to receive the cursor control member.

37. An electronic device comprising:
a base;
a display;
a cursor control member including an elongate, slender, rigid housing, the cursor control member having an attachment element arranged at one end of the housing for detachably fixing the cursor control member to the base;
a port carried by the base for receiving the attachment element of the cursor control member, the port being adapted to translate movement of the cursor control member into control signals for directing movement of a cursor in the display when the cursor control member is engaged with the port; and
wherein an end of the cursor control member has a stylus tip.

38. The electronic device according to claim 37 wherein the port is arranged on an adapter that is releasably connectable to the base.

39. The electronic device according to claim 37 wherein the cursor control member includes a manually operable input mechanism that produces control signals when operated and the attachment element and port are configured so as to communicate those control signals to a processing unit in the base.

40. The electronic device according to claim 39 wherein the input mechanism comprises a button.

41. The electronic device according to claim 39 wherein the input mechanism comprises a wheel.

42. The electronic device according to claim 39 wherein the input mechanism comprises a touch surface.

43. The electronic device according to claim 37 wherein the cursor control member has a memory and the port and the attachment element of the cursor control member are configured such that content stored in the memory of the cursor control member can be communicated to a processing unit in the base when the cursor control member is engaged with the port.

44. The electronic device according to claim 37 wherein the cursor control member has a memory and the port and attachment element of the cursor control member are configured such that the memory of the cursor control member is usable by a processing unit in the base when the cursor control member is engaged with the port.

45. The electronic device according to claim 37 wherein the cursor control member includes a power supply and the port and attachment element of the cursor control member are configured such that power produced by the power supply in the cursor control member is available to operate the processing unit in the base when the cursor control member is engaged with the port.

46. The electronic device according to claim 37 further including a storage slot on the base, the storage slot being configured to receive the cursor control member.

47. An electronic device comprising:
a base including a processing unit;
a display;
a cursor control member including a housing, the cursor control member having an attachment element arranged at one end of the housing for detachably securing the cursor control member to the base and a memory; and
a port carried by the base for receiving the attachment element of the cursor control member, the port being adapted to translate movement of the cursor control member into control signals for directing movement of a cursor in the display when the cursor control member is engaged with the port and wherein the port and the attachment element of the cursor control member are configured such that content stored in the memory of the cursor control member can be communicated to the processing unit in the base when the cursor control member is engaged with the port.

48. The electronic device according to claim 47 wherein the port is arranged on an adapter that is releasably connectable to the base.

49. The electronic device according to claim 47 wherein the cursor control member includes a manually operable input mechanism that produces control signals when operated and the attachment element and port are configured so as to communicate those control signals to a processing unit in the base.

50. The electronic device according to claim 49 wherein the input mechanism comprises a button.

51. The electronic device according to claim 49 wherein the input mechanism comprises a wheel.

52. The electronic device according to claim 49 wherein the input mechanism comprises a touch surface.

53. The electronic device according to claim 47 wherein the cursor control member has a memory and the port and attachment element of the cursor control member are configured such that the memory of the cursor control member is usable by a processing unit in the base when the cursor control member is engaged with the port.

54. The electronic device according to claim 47 wherein the cursor control member includes a power supply and the port and attachment element of the cursor control member are configured such that power produced by the power supply in the cursor control member is available to operate the processing unit in the base when the cursor control member is engaged with the port.

55. The electronic device according to claim 47 further including a storage slot on the base, the storage slot being configured to receive the cursor control member.

56. The electronic device according to claim 47 wherein the processing unit of the base produces a second control signal that controls movement of the cursor control member upon occurrence of a predetermined event when the cursor control member is engaged with the port.

57. An electronic device comprising:
a base including a processing unit;
a display;
a cursor control member including a housing, the cursor control member having an attachment element arranged at one end of the housing for detachably securing the cursor control member to the base and a memory; and
a port carried by the base for receiving the attachment element of the cursor control member, the port including a movable surface that moves in response to movement of the cursor control member when the cursor control member is engaged with the port, movement of the movable surface producing control signals for directing movement of a cursor in the display and wherein the port and attachment element of the cursor control member are configured such that the memory of the cursor control member is usable by the processing unit in the base when the cursor control member is engaged with the port.

58. The electronic device according to claim 57 wherein the port is arranged on an adapter that is releasably connectable to the base.

59. The electronic device according to claim 57 wherein the cursor control member includes a manually operable input mechanism that produces control signals when operated and the attachment element and port are configured so as to communicate those control signals to a processing unit in the base.

60. The electronic device according to claim 59 wherein the input mechanism comprises a button.

61. The electronic device according to claim 59 wherein the input mechanism comprises a wheel.

62. The electronic device according to claim 59 wherein the input mechanism comprises a touch surface.

63. The electronic device according to claim 57 wherein the cursor control member includes a power supply and the port and attachment element of the cursor control member are configured such that power produced by the power supply in the cursor control member is available to operate the processing unit in the base when the cursor control member is engaged with the port.

64. The electronic device according to claim 57 further including a storage slot on the base, the storage slot being configured to receive the cursor control member.

65. The electronic device according to claim 57 wherein the processing unit of the base produces a second control signal that controls movement of the cursor control member upon occurrence of a predetermined event when the cursor control member is engaged with the port.

66. An electronic device comprising:
a base including a processing unit;
a display;
a cursor control member including a housing, the cursor control member having an attachment element arranged at one end of the housing for detachably securing the cursor control member to the base and a power supply; and
a port carried by the base for receiving the attachment element of the cursor control member, the port including a movable surface that moves in response to movement of the cursor control member when the cursor control member is engaged with the port, movement of the movable surface producing control signals for directing movement of a cursor in the display and wherein the port and attachment element of the cursor control member are configured such that power produced by the power supply in the cursor control member is available to operate the processing unit in the base when the cursor control member is engaged with the port.

67. The electronic device according to claim 66 wherein the port is arranged on an adapter that is releasably connectable to the base.

68. The electronic device according to claim 66 wherein the cursor control member includes a manually operable input mechanism that produces control signals when operated and the attachment element and port are configured so as to communicate those control signals to a processing unit in the base.

69. The electronic device according to claim 68 wherein the input mechanism comprises a button.

70. The electronic device according to claim 68 wherein the input mechanism comprises a wheel.

71. The electronic device according to claim 68 wherein the input mechanism comprises a touch surface.

73. The electronic device according to claim 66 further including a storage slot on the base, the storage slot being configured to receive the cursor control member.

74. The electronic device according to claim 66 wherein the processing unit of the base produces a second control signal that controls movement of the cursor control member upon occurrence of a predetermined event when the cursor control member is engaged with the port.

75. An electronic device comprising:
a base;
a display;
a cursor control member including a housing, the cursor control member having an attachment element arranged at one end of the housing for detachably securing the cursor control member to the base;
a port carried by the base for receiving the attachment element of the cursor control member, the port including a movable surface that moves in response to movement of the cursor control member when the cursor control member is engaged with the port, movement of the movable surface producing control signals for directing movement of a cursor in the display; and
a storage slot on the base, the storage slot being configured to receive the cursor control member.

75. The electronic device according to claim 74 wherein the port is arranged on an adapter that is releasably connectable to the base.

76. The electronic device according to claim 74 wherein the cursor control member includes a manually operable input mechanism that produces control signals when operated and the attachment element and port are configured so as to communicate those control signals to a processing unit in the base.

77. The electronic device according to claim 76 wherein the input mechanism comprises a button.

78. The electronic device according to claim 76 wherein the input mechanism comprises a wheel.

79. The electronic device according to claim 76 wherein the input mechanism comprises a touch surface.

80. A cursor control member for an electronic device having a display and a port, the port including a movable surface that moves in response to movement of the cursor control member when the cursor control member is engaged with the port, movement of the movable surface producing control signals for directing movement of a cursor in the display, the cursor control member comprising an elongate, slender, rigid housing with an attachment element arranged at one end of the housing which can be received in the port and wherein an end of the housing is configured as a stylus tip.

81. A cursor control member for an electronic device having a display and a port, the port being adapted to translate movement of the cursor control member into control signals for directing movement of a cursor in the display of the electronic device when the cursor control member is engaged with the port, the cursor control member comprising an elongate, slender, rigid housing with an attachment element arranged at one end of the housing which can be received in the port and a memory, wherein the memory is accessible by the electronic device when the cursor control member is engaged in the port.
